(19) United States
(12) Patent Application Publication
(10) Pub. No.: US 2026/0142088 A1
(43) Pub. Date: May 21, 2026

(54) MULTILAYER ELECTRONIC COMPONENT

(71) Applicant: SAMSUNG ELECTRO-MECHANICS CO., LTD., Suwon-si (KR)

(72) Inventors: Won Hyo Joo, Suwon-si (KR); Min Jae Son, Suwon-si (KR); Seon Ho Park, Suwon-si (KR); Eui Jung Chun, Suwon-si (KR); Hui Jin Kang, Suwon-si (KR); Ka Young Kim, Suwon-si (KR); Hyeun Tea Yoon, Suwon-si (KR); Eun Yong Jang, Suwon-si (KR); Pum San Chae, Suwon-si (KR); Gi Sub Lee, Suwon-si (KR); Ju Yeon Cho, Suwon-si (KR); Ji Yun An, Suwon-si (KR); Ah Young Lee, Suwon-si (KR)

(73) Assignee: SAMSUNG ELECTRO-MECHANICS CO., LTD., Suwon-si (KR)

(21) Appl. No.: 19/296,497

(22) Filed: Aug. 11, 2025

(30) Foreign Application Priority Data
Nov. 20, 2024 (KR) 10-2024-0166519

(51) Int. Cl. H01G 4/30; H01G 4/012

(52) U.S. Cl. CPC H01G 4/30; H01G 4/012

(57) ABSTRACT

A multilayer electronic component according to an embodiment of the present disclosure includes a body including a capacitance forming portion including a dielectric layer and an internal electrode layer, and a cover portion; and an external electrode disposed on the body, wherein the cover portion includes a plurality of dummy electrode layers disposed to be spaced apart from the capacitance forming portion in the first direction, and the dummy electrode layers include dummy electrodes disposed to be spaced apart from each other in a second direction and connected to the external electrode, and a dummy electrode layer disposed in a position closest to the capacitance forming portion is disposed in a position spaced apart from the capacitance forming portion by d in the first direction, and, if a first direction average length of the dielectric layer is td, td and d satisfy td<d.

### CROSS-REFERENCE TO RELATED APPLICATION(S)

This application claims benefit of priority to Korean Patent Application No. 10-2024-0166519 filed on Nov. 20, 2024 in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, may be a chip condenser mounted on the printed circuit boards of various types of electronic products such as image display devices including a liquid crystal display (LCD), a plasma display panel (PDP), or the like, a computer, a smartphone, a mobile phone, or the like, serving to charge or discharge electricity therein or therefrom.

Such a multilayer ceramic capacitor may be used as a component of various electronic devices, as the multilayer ceramic capacitor has a small size with high capacitance and is easily mounted. As various electronic devices such as computers, mobile devices, or the like have been miniaturized and implemented with high-output, demand for miniaturization and high capacitance in multilayer ceramic capacitors has increased.

Meanwhile, there may be a need to improve bending strength of multilayer electronic components to ensure stability against external vibrations or shocks. Accordingly, bending strength may be improved by disposing an electrode or the like not forming capacitance in upper and lower regions of a multilayer electronic component body in which an internal electrode is not stacked, but optimal bending strength may be different depending on arrangement or position of the electrode, and when a region in which the electrode is disposed increases for simple improvement of bending strength, a unit price of manufacturing costs of the multilayer electronic component may increase, resulting in a decrease in economic efficiency. Therefore, it is necessary to solve this problem.

### SUMMARY

One of the problems to be solved by the present disclosure is to provide a multilayer electronic component having improved bending strength.

The various problems to be solved by the present disclosure are not limited to the above-described contents, and can be more easily understood in the process of explaining specific embodiments of the present disclosure.

According to an aspect of the present disclosure, a multilayer electronic component includes a body including a capacitance forming portion including a dielectric layer and internal electrode layers alternately disposed with the dielectric layer in a first direction, and a cover portion disposed on both end surfaces of the capacitance forming portion in the first direction, the body including first and second surfaces opposing each other in the first direction, third and fourth surfaces connected to the first and second surfaces and opposing each other in a second direction, and fifth and sixth surfaces connected to the first to fourth surfaces and opposing each other in a third direction; and an external electrode disposed on the body, wherein the cover portion includes a plurality of dummy electrode layers disposed to be spaced apart from the capacitance forming portion in the first direction, and the plurality of dummy electrode layers include dummy electrodes disposed to be spaced apart from each other in the second direction and connected to the external electrode, among the plurality of dummy electrode layers, a dummy electrode layer disposed in a position closest to the capacitance forming portion is disposed in a position spaced apart from the capacitance forming portion by d in the first direction, and, if an average length in the first direction of the dielectric layer is td, td and d satisfy td<d.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 schematically illustrates a perspective view of a multilayer electronic component according to an embodiment of the present disclosure.

FIG. 2 schematically illustrates an exploded perspective view illustrating a stack structure of internal electrode layers according to an embodiment of the present disclosure.

FIG. 3 schematically illustrates a cross-sectional view of a multilayer electronic component illustrated in FIG. 1, taken along line I-I′, according to an embodiment of the present disclosure.

FIG. 4 schematically illustrates an exploded perspective view illustrating a stack structure of internal electrode layers according to another embodiment of the present disclosure.

FIG. 5 schematically illustrates a cross-sectional view of a multilayer electronic component illustrated in FIG. 1, taken along line I-I′, according to another embodiment of the present disclosure.

FIG. 6 schematically illustrates a cross-sectional view of a multilayer electronic component illustrated in FIG. 1, taken along line II-II′, according to an embodiment of the present disclosure.

### DETAILED DESCRIPTION

Hereinafter, embodiments of the present disclosure will be described with reference to specific embodiments and the accompanying drawings. However, embodiments of the present disclosure may be modified into various other forms, and the scope of the present disclosure is not limited to the embodiments described below. Further, embodiments of the present disclosure may be provided for a more complete description of the present disclosure to the ordinary artisan. Therefore, shapes, sizes, and the like, of the elements in the drawings may be exaggerated for clarity of description, and the elements denoted by the same reference numerals in the drawings may be the same elements.

In addition, in order to clearly explain the present disclosure in the drawings, portions not related to the description will be omitted for clarification of the present disclosure, and a thickness may be enlarged to clearly illustrate layers and regions. The same reference numerals will be used to designate the same components in the same reference numerals. Further, throughout the specification, when an element is referred to as “comprising” or “including” an element, it means that the element may further include other elements as well, without departing from the other elements, unless specifically stated otherwise.

In the drawing, a first direction may be defined as a stack direction or a thickness T direction or Z-direction, a second direction may be defined as a length L direction or X-direction, and a third direction may be defined as a width W direction or a Y-direction.

### Multilayer Electronic Component

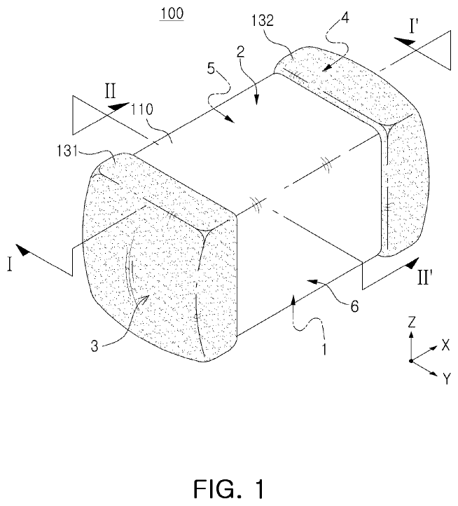

FIG. 1 schematically illustrates a perspective view of a multilayer electronic component according to an embodiment of the present disclosure.

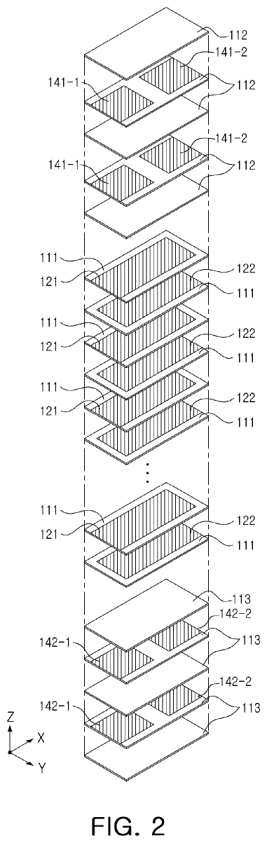

FIG. 2 schematically illustrates an exploded perspective view illustrating a stack structure of internal electrode layers according to an embodiment of the present disclosure.

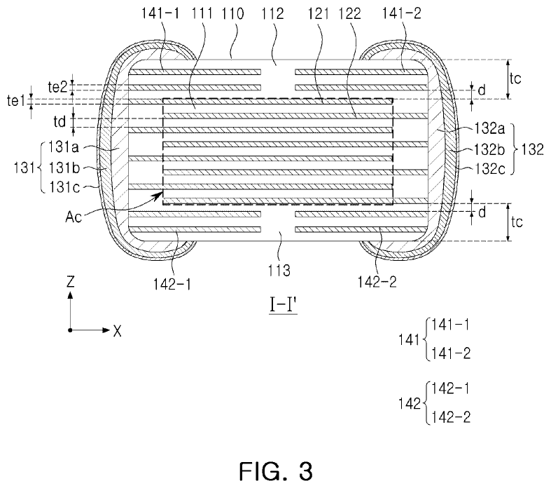

FIG. 3 schematically illustrates a cross-sectional view of a multilayer electronic component illustrated in FIG. 1, taken along line I-I′, according to an embodiment of the present disclosure.

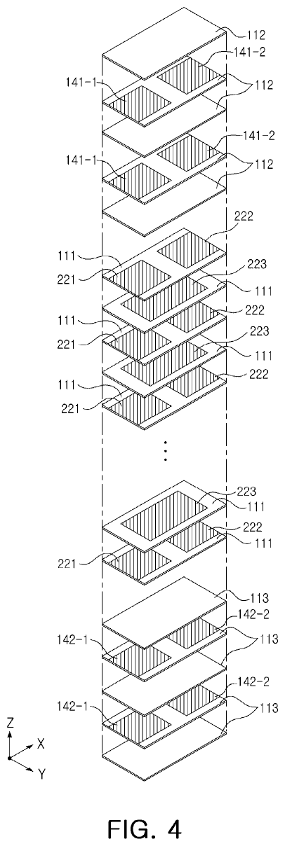

FIG. 4 schematically illustrates an exploded perspective view illustrating a stack structure of internal electrode layers according to another embodiment of the present disclosure.

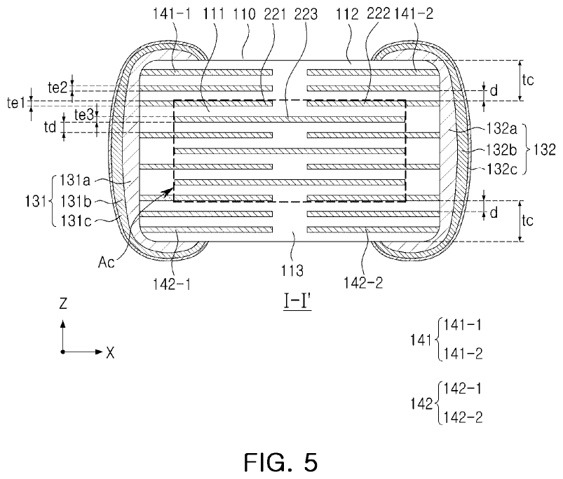

FIG. 5 schematically illustrates a cross-sectional view of a multilayer electronic component illustrated in FIG. 1, taken along line I-I′, according to another embodiment of the present disclosure.

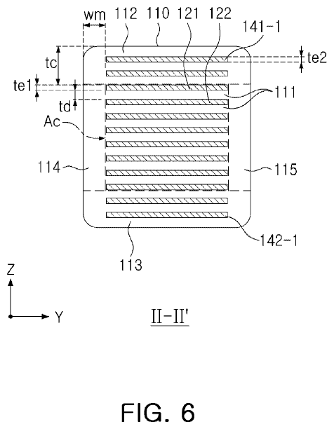

FIG. 6 schematically illustrates a cross-sectional view of a multilayer electronic component illustrated in FIG. 1, taken along line II-II′, according to an embodiment of the present disclosure.

Hereinafter, with reference to FIGS. 1 to 6, a multilayer electronic component according to an embodiment of the present disclosure will be described in detail. A multilayer ceramic capacitor will be described as an example of a multilayer electronic component, but the example embodiment may also be applied to various electronic products using a dielectric composition, such as an inductor, a piezoelectric element, a varistor, a thermistor, or the like.

According to an embodiment of the present disclosure, a multilayer electronic component 100 includes a body 110 including a capacitance forming portion Ac including a dielectric layer 111 and an internal electrode layer (121, 122, 221, and 222) alternately disposed with the dielectric layer 111 in a first direction, and a cover portion (112 and 113) disposed on both end surfaces of the capacitance forming portion Ac in the first direction, the body including first and second surfaces 1 and 2 opposing each other in the first direction, third and fourth surfaces 3 and 4 connected to the first and second surfaces 1 and 2 and opposing each other in a second direction, and fifth and sixth surfaces 5 and 6 connected to the first to fourth surfaces 1, 2, 3, and 4 and opposing each other in a third direction; and an external electrode (131 and 132) disposed on the body 110, wherein the cover portion (112 and 113) includes a plurality of dummy electrode layers (141 and 142) disposed to be spaced apart from the capacitance forming portion Ac in the first direction, and the dummy electrode layers (141 and 142) include dummy electrodes (141-1, 141-2, 142-1, and 142-2) disposed to be spaced apart from each other in the second direction and connected to the external electrode (131 and 132), and a dummy electrode layer (141 and 142) disposed in a position closest to the capacitance forming portion Ac, among the plurality of dummy electrode layers (141 and 142), is disposed in a position spaced apart from the capacitance forming portion Ac by d in the first direction, and, if a first direction average length of the dielectric layer 111 is td, td and d satisfy td<d.

The body 110 may include the capacitance forming portion Ac in which the dielectric layer 111 and the internal electrode layer (121, 122, 221, and 222) are alternately stacked to form capacitance.

Although a specific shape of the body 110 is not particularly limited, the body 110 may have a hexahedral shape or the like, as illustrated. Due to shrinkage of ceramic powder particles included in the body 110 during a sintering process, the body 110 may not have a perfectly straight hexahedral shape, but may have a substantially hexahedral shape.

The body 110 may include first and second surfaces 1 and 2 opposing each other in a first direction, third and fourth surfaces 3 and 4 connected to the first and second surfaces 1 and 2 and opposing each other in a second direction, and fifth and sixth surfaces 5 and 6 connected to the first to fourth surfaces 1, 2, 3, and 4 and opposing each other in a third direction.

A plurality of dielectric layers 111 forming the body 110 may be in a sintered state, and a boundary between adjacent dielectric layers 111 may be integrated to such an extent that it may be difficult to identify the same without using a scanning electron microscope (SEM).

A raw material for forming the dielectric layer 111 is not particularly limited, as long as sufficient capacitance may be obtained therewith. In general, a perovskite (ABO₃)-based material may be used, for example, a barium titanate-based material, a lead composite perovskite-based material, a strontium titanate-based material, or the like may be used. The barium titanate-based material may include a BaTiO₃-based ceramic powder, and examples of the ceramic powder may include BaTiO₃, or (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), or the like, in which calcium (Ca), zirconium (Zr), or the like is partially dissolved in BaTiO₃, or the like.

In addition, various ceramic additives, organic solvents, binders, dispersants, or the like may be added to powders of barium titanate (BaTiO₃) and the like, as the raw material for forming the dielectric layer 111, according to the purpose of the present disclosure.

To distinguish the dielectric layer 111 included in the capacitance forming portion Ac from a dielectric layer included in the cover portion (112 and 113) to be described later, a dielectric layer included in the capacitance forming portion Ac may be defined as a first dielectric layer, and a dielectric layer included in the cover portion (112 and 113) may be defined as a second dielectric layer.

In addition, the first and second dielectric layers may be formed using a dielectric material such as barium titanate (BaTiO₃), and may thus include a dielectric microstructure after sintering. The dielectric microstructure may include a plurality of grains, grain boundaries disposed between adjacent grains, and n-points disposed at points at which three or more grain boundaries meet, and the number of grains, grain boundaries, and n-points may be plural, respectively.

A first direction length td (a length in the first direction) of the dielectric layer 111 does not need to be particularly limited.

To secure reliability of the multilayer electronic component 100 under a high voltage environment, the first direction length td of the dielectric layer 111 may be 10.0 μm or less (td≤10 μm). In addition, to achieve miniaturization and high capacitance of the multilayer electronic component 100, the first direction length td of the dielectric layer 111 may be 3.0 μm or less. To more easily achieve miniaturization and high capacitance, the first direction length td of the dielectric layer 111 may be 1.0 μm or less, preferably 0.6 μm or less, and more preferably 0.4 μm or less.

In this case, the first direction length td of the dielectric layer 111 may be a concept including a first direction length td of at least one of the plurality of dielectric layers 111, or may be a concept including a first direction length td of each of all dielectric layers 111.

In this case, the first direction length td of the dielectric layer 111 may mean a first direction length td of a dielectric layer 111 disposed between the first and second internal electrodes 121 and 122.

The first direction length td of the dielectric layer 111 may mean a length, a distance, a size, a length, or the like of the dielectric layer 111 in the first direction, or may mean a thickness of the dielectric layer.

In addition, the first direction length td of the dielectric layer 111 may mean a first direction average length td (an average length in the first direction) of one dielectric layer 111, may mean a first direction average length td (an average length in the first direction) of each of the plurality of dielectric layers 111, or may mean a first direction average length td (an average length in the first direction) of the plurality of dielectric layers 111.

The first direction average length of the dielectric layer 111 may be measured by scanning images of the first and second direction cross-sections of the body 110 with a scanning electron microscope (SEM) at 10,000× magnification. More specifically, the first direction average length of one dielectric layer 111 may mean an average value calculated by measuring first direction lengths of one dielectric layer 111 at five (5) equally spaced points in the second direction in scanned images. The five (5) equally spaced points may be designated in the capacitance forming portion Ac. In addition, when this average value measurement is extended to three dielectric layers to measure an average value, the first direction average length of plurality of dielectric layers may be further generalized. Other methods and/or tools appreciated by one of ordinary skill in the art, even if not described in the present disclosure, may also be used.

In an embodiment of the present disclosure, the internal electrode layer may include a first internal electrode layer and a second internal electrode layer, alternately disposed to face each other, with the dielectric layer 111 interposed therebetween.

The first internal electrode layer may include a first internal electrode 121 connected to the first external electrode 131, and the second internal electrode layer may include a second internal electrode 122 connected to the second external electrode 131.

More specifically, the first internal electrode 121 may be spaced apart from the fourth surface 4, and may be exposed through the third surface 3 while in contact with the third surface 3, and the second internal electrode 122 may be spaced apart from the third surface 3, and may be exposed through the fourth surface 4 while in contact with the fourth surface 4. The first external electrode 131 may be disposed on the third surface 3 of the body 110, and may be connected to the first internal electrode 121, and the second external electrode 132 may be disposed on the fourth surface 4 of the body 110, and may be connected to the second internal electrode 122.

For example, the first internal electrode 121 may not be connected to the second external electrode 132 but may be connected to the first external electrode 131, and the second internal electrode 122 may not be connected to the first external electrode 131 but may be connected to the second external electrode 132. In this case, the first and second internal electrodes 121 and 122 may be electrically separated from each other by the dielectric layer 111 disposed therebetween in the first direction.

In this case, the body 110 may be formed by alternately stacking and then sintering a first ceramic green sheet on which a paste for the first internal electrode, which will be the first internal electrode 121, is printed, and a second ceramic green sheet on which a paste for the second internal electrode, which will be the second internal electrode 122, is printed. A printing method of a conductive paste for the first and second internal electrodes may use a screen printing method, a gravure printing method, or the like, but the present disclosure is not limited thereto.

A material forming the first and second internal electrodes 121 and 122 is not particularly limited, and a material having excellent electrical conductivity may be used. For example, the first and second internal electrodes 121 and 122 may include one or more of nickel (Ni), copper (Cu), palladium (Pd), silver (Ag), gold (Au), platinum (Pt), tin (Sn), tungsten (W), titanium (Ti), and an alloy thereof.

In another embodiment of the present disclosure, the internal electrode layer may include a third internal electrode layer and a fourth internal electrode layer, alternately disposed to face each other, with the dielectric layer 111 therebetween.

The third internal electrode layer may include third and fourth internal electrodes 221 and 222 disposed to be spaced apart from each other in the second direction and connected to the first and second external electrodes 131 and 132, respectively, and the fourth internal electrode layer may include a floating electrode 223 not connected to the first and second external electrodes 131 and 132.

More specifically, the third internal electrode 221 may be spaced apart from the fourth surface 4, and may be exposed through the third surface 3 while in contact with the third surface 3, and the fourth internal electrode 222 may be spaced apart from the third surface 3, and may be exposed through the fourth surface 4 while in contact with the fourth surface 4. The third internal electrode 221 and the fourth internal electrode 222 may be spaced apart from each other in the second direction, and may not be connected. The first external electrode 131 may be disposed on the third surface 3 of the body 110 and connected to the third internal electrode 221, and the second external electrode 132 may be disposed on the fourth surface 4 of the body 110 and connected to the fourth internal electrode 222.

For example, the first internal electrode 121 may be connected to the first external electrode 131 without being connected to the second external electrode 132, and the second internal electrode 122 may be connected to the second external electrode 132 without being connected to the first external electrode 131. In this case, the first and second internal electrodes 121 and 122 may be spaced apart from each other in the second direction, and may thereby be electrically separated from each other.

The floating electrode 223 may be spaced apart from the third and fourth surfaces 3 and 4, and may not be connected to the first and second external electrodes 131 and 132.

In addition, the third internal electrode layer including the first and second internal electrodes 121 and 122, and the fourth internal electrode layer including the floating electrode 223 may be electrically separated from each other by the dielectric layer 111 disposed therebetween in the first direction.

In this case, the body 110 may be formed by alternately stacking and then sintering a first ceramic green sheet on which a paste for the third and fourth internal electrodes, which will be the third and fourth internal electrodes 221 and 222, is printed, and a second ceramic green sheet on which a paste for the floating electrode, which will be the floating electrode 223, is printed. A printing method of a conductive paste for the third and fourth internal electrodes and the paste for the floating electrode may use a screen printing method, a gravure printing method, or the like, but the present disclosure is not limited thereto.

A material forming the third and fourth internal electrodes 221 and 222 and the floating electrode 223 is not particularly limited, and a material having excellent electrical conductivity may be used. For example, the third and fourth internal electrodes 221 and 222 and the floating electrode 223 may include one or more of nickel (Ni), copper (Cu), palladium (Pd), silver (Ag), gold (Au), platinum (Pt), tin (Sn), tungsten (W), titanium (Ti), and an alloy thereof.

A first direction length of the internal electrode layer does not need to be particularly limited.

Hereinafter, the description of the first direction length of the internal electrode layer may be a description of the first direction length of each of the first and second internal electrode layers or the third and fourth internal electrode layers, and more specifically, may mean a first direction length te1 of each of the first internal electrode 121 and the second internal electrode 122, or a first direction length te1 of each of the third internal electrode 221 and the fourth internal electrode 222, or a first direction length te3 of each of the floating electrodes 223.

To secure reliability of the multilayer electronic component 100 under a high voltage environment, the first direction length (te1 and te3) of the internal electrode layer may be 3.0 μm or less. In addition, to achieve miniaturization and high capacitance of the multilayer electronic component 100, the first direction length (te1 and te3) of the internal electrode layer may be 1.0 μm or less. To more easily achieve ultra-miniaturization and high capacitance, the first direction length (te1 and te3) of the internal electrode layer may be 0.6 μm or less, and more preferably 0.4 μm or less.

In this case, the first direction length (te1 and te3) of the internal electrode layer may be a concept including a first direction length (te1 and te3) of at least one of the plurality of internal electrode layers, or may be a concept including a thickness (te1 and te3) of all the internal electrode layers.

The first direction length (te1 and te3) of the internal electrode layer may mean a length, a distance, a size, a length, or the like of the internal electrode layer in the first direction, or may mean a thickness of the internal electrode layer. In addition, the first direction length (te1 and te3) of the internal electrode layer may mean a first direction average length (te1 and te3) of one internal electrode layer, or may mean a first direction average length (te1 and te3) of the plurality of internal electrode layers.

The first direction average length of the internal electrode layer may be measured by scanning images of the first and second direction cross-sections of the body 110 with a scanning electron microscope (SEM) at 10,000× magnification. More specifically, the first direction average length of one internal electrode layer may be an average value calculated by measuring first direction lengths of one internal electrode layer at five (5) equally spaced points in the second direction in the scanned images. The five (5) equally spaced points may be designated in the capacitance forming portion Ac. In addition, when this average value measurement is extended to three internal electrode layers to measure an average value, the first direction average length of the plurality of internal electrode layers may be further generalized. In this case, the internal electrode layer may mean one of the first internal electrode, the second internal electrode, the third internal electrode, the fourth internal electrode, or the floating electrode, and a person of ordinary skill in the art will be able to measure the first direction length or the first direction average length of each of the first internal electrode, the second internal electrode, the third internal electrode, the fourth internal electrode, or the floating electrode.

In an embodiment of the present disclosure, a first direction average length td of at least one of the plurality of dielectric layers, and a first direction average length (te1 and te3) of at least one of the plurality of internal electrode layers may satisfy 2×te1<td or 2×te3<td.

For example, a first direction average length td of one dielectric layer may be larger than twice a first direction average length (te1 and te3) of one internal electrode layer. Preferably, a first direction average length td of the plurality of dielectric layers may be larger than twice a first direction average length (te1 and te3) of the plurality of internal electrode layers.

Generally, reliability issues due to a decrease in breakdown voltage (BDV) under a high voltage environment may be a major issue for high-voltage electrical electronic components.

Therefore, to prevent a decrease in breakdown voltage under a high voltage environment, the first direction average length td of the dielectric layer may be made greater than twice the first direction average length (te1 and te3) of the internal electrode layer, thereby improving breakdown voltage characteristics.

When the first direction average length td of the dielectric layer is equal to or less than twice the first direction average length (te1 and te3) of the internal electrode layer, breakdown voltage may be decreased and a short-circuit may occur between internal electrode layers.

The body 110 may include a cover portion (112 and 113) disposed on first direction end-surfaces of the capacitance forming portion Ac.

Specifically, the cover portion (112 and 113) may include a first cover portion 112 disposed on one surface of the capacitance forming portion Ac in the first direction, and a second cover portion 113 disposed on the other surface of the capacitance forming portion Ac in the second direction. More specifically, for example, the cover portion (112 and 113) may include a first cover portion 112 disposed above the capacitance forming portion Ac in the first direction, and a second cover portion 113 disposed below the capacitance forming portion Ac in the first direction.

The first cover portion 112 and the second cover portion 113 may be formed by disposing or stacking a single second dielectric layer or two or more second dielectric layers on upper and lower surfaces of the capacitance forming portion Ac in the first direction, respectively, and may basically perform a role of preventing damage to the internal electrode layer due to physical or chemical stress.

The first cover portion 112 and the second cover portion 113 may not include the internal electrode, and may include the same dielectric or ceramic material as the first dielectric layer 111 of the capacitance forming portion Ac. For example, the first cover portion 112 and the second cover portion 113 may include a dielectric material, and for example, may include a barium titanate (BaTiO₃)-based dielectric material.

A first direction length tc of the cover portion (112 and 113) does not need to be particularly limited, and the following description of the first direction length tc of the cover portion (112 and 113) may mean a first direction length tc of each of the first cover portion 112 and the second cover portion 113.

To more easily achieve miniaturization and high capacitance of the multilayer electronic component 100, the first direction length tc of the cover portion (112 and 113) may be 400 μm or less, 380 μm or less, 200 μm or less, 100 μm or less, 50 μm or less, 30 μm or less, or 20 μm or less. A lower limit value may be, but not specifically limited to, 5 μm or more, 10 μm or more, 20 μm or more, 30 μm or more, 50 μm or more, or 100 μm or more.

In addition, the first direction length tc of the cover portion (112 and 113) may mean a first direction average length tc of each of the first and second cover portions 112 and 113, or may mean a first direction average length tc of the first and second cover portions 112 and 113.

The first direction average length of the cover portion (112 and 113) may be measured by scanning images of the first and second direction cross-sections of the body 110 with a scanning electron microscope (SEM) at 10,000× magnification. More specifically, the first direction average length may mean an average value calculated by measuring lengths in the first direction at five (5) equally spaced points in the second direction in scanned images of one cover portion.

In addition, the first direction average length of the cover portion (112 and 113) measured by the above-described method may have a value substantially the same as the first direction average length of the cover portion (112 and 113) in the first and third direction cross-sections of the body 110.

There may be a need to improve bending strength of multilayer electronic components to ensure stability against external vibration or shock. Therefore, bending strength may be improved by disposing an electrode or the like not forming capacitance in upper and lower regions of a multilayer electronic component body in which an internal electrode is not stacked, but optimal bending strength may be different depending on arrangement or position of the electrode, and when a region in which the electrode is disposed increases for simple improvement of bending strength, a unit price of manufacturing cost of the multilayer electronic component may increase, resulting in a decrease in economic efficiency. Therefore, it is necessary to solve this problem.

Therefore, in an embodiment of the present disclosure, the cover portion (112 and 113) may include a plurality of dummy electrode layers (141 and 142) disposed to be spaced apart from the capacitance forming portion Ac in the first direction, and the dummy electrode layers (141 and 142) may include dummy electrodes (141-1, 141-2, 142-1, and 142-2) disposed to be spaced apart from each other in the second direction and connected to the external electrode (131 and 132), and a dummy electrode layer (141 and 142) disposed in a position closest to the capacitance forming portion Ac, among the plurality of dummy electrode layers (141 and 142), may be disposed in a position spaced apart from the capacitance forming portion Ac by d in the first direction, and, if a first direction average length of the dielectric layer 111 is td, td and d may satisfy td<d.

In this case, the “a dummy electrode layer (141 and 142) disposed in a position closest to the capacitance forming portion Ac, among the plurality of dummy electrode layers (141 and 142)” may mean a dummy electrode layer (141 and 142) disposed in a position closest to an internal electrode layer disposed on an outermost layer in the first direction, among the capacitance forming portions Ac, in the first direction, and a first direction length between an internal electrode layer disposed on an outermost layer in the first direction, among the capacitance forming portions Ac, and the dummy electrode layer (141 and 142), may be referred to as d.

In this case, the cover portion (112 and 113) may be formed by alternately stacking and then sintering a third ceramic green sheet on which a dummy electrode paste is not printed and a fourth ceramic green sheet on which a dummy electrode paste is printed. In this case, the fourth ceramic green sheet on which the dummy electrode paste is printed may also be formed by continuously stacking and then sintering. In this case, a plurality of dummy electrode layers (141 and 142) may be included, with the second dielectric layer interposed therebetween, in the first direction.

In this case, a printing method of a paste for the dummy electrode may use a screen printing method, a gravure printing method, or the like, but the present disclosure is not limited thereto.

In this case, a lower limit value of an interval d at which the dummy electrode layer (141 and 142) is spaced apart from the capacitance forming portion Ac may be greater than an average thickness td of one dielectric layer 111. For example, td<d may be satisfied.

When an interval d at which the dummy electrode layer (141 and 142) disposed in the position closest to the capacitance forming portion Ac, among the plurality of dummy electrode layers (141 and 142), in the first direction is spaced apart from the capacitance forming portion Ac in the first direction is greater than the average length td of the dielectric layer in the first direction (td<d), influence of current applied to the internal electrode layer (121 and 122) on the dummy electrode layer (141 and 142) may be minimized, thereby preventing an unintended short-circuit defect of the multilayer electronic component 100. Interval d may be measured by a scanning electron microscope (SEM). Other methods and/or tools appreciated by one of ordinary skill in the art, even if not described in the present disclosure, may also be used.

The plurality of dummy electrode layers (141 and 142) may be disposed in a position spaced apart from the capacitance forming portion Ac by 42% or more and 71% or less in the cover portion (112 and 113).

For example, the plurality of dummy electrode layers (141 and 142) may be disposed in a region spaced apart from the capacitance forming portion Ac by 42% or more and 71% or less in the cover portion (112 and 113).

For a more specific example of the position in which the dummy electrode layer (141 and 142) is spaced apart from the capacitance forming portion Ac in the first direction, when an average thickness of each of the cover portion (112 and 113) disposed on both end surfaces of the capacitance forming portion Ac in the first direction is 380 μm, the dummy electrode layer (141 and 142) may be disposed in a position spaced apart from the internal electrode layers (121 and 122) disposed on outermost layers in both directions in the first direction of the capacitance forming portion Ac among the cover portion (112 and 113) by 160 μm (42%) or more and 270 μm (71%) or less in the first direction. The position of the dummy electrode layer may be measured by a scanning electron microscope (SEM). Other methods and/or tools appreciated by one of ordinary skill in the art, even if not described in the present disclosure, may also be used.

The dummy electrode layer (141 and 142) may be disposed in a position spaced apart by 42% or more and 71% or less from the capacitance forming portion Ac in the first direction, bending strength of the multilayer electronic component 100 may be further improved.

When the dummy electrode (141 and 142) is located in a position less than 42% apart from the capacitance forming portion Ac in the first direction, there may be a concern that a short-circuit defect of the multilayer electronic component 100 occurs or that a bending strength improvement effect may not be sufficiently improved, and when the dummy electrode (141 and 142) is located in a position more than 71% apart from the capacitance forming portion Ac in the first direction, bending strength may be sufficiently improved, but when excessive external force is applied, the dummy electrode (141 and 142) may be broken, making it difficult to secure reliable mechanical strength, or there may be a concern that the dummy electrode (141 and 142) is oxidized due to moisture penetration from the outside, and there may be a concern that the dummy electrode layer (141 and 142) is adjacent to a surface of the body 110, for example, the first and second surfaces, and that arc discharge (surface arcing) occurs on the surface.

In this case, to improve bending strength, it may be sufficient for the dummy electrode layer (141 and 142) to be included only in the cover portion (112 and 113), and the dummy electrode layer (141 and 142) does not need to be included in both the cover portion (112 and 113). The dummy electrode layers may be disposed in the cover portion close to a mounting surface, to improve bending strength more effectively.

For example, the dummy electrode layer (141 and 142) may be disposed on at least one of the first cover portion 112 disposed above the capacitance forming portion Ac in the first direction, or the second cover portion 113 disposed below the capacitance forming portion Ac in the second direction, and preferably, the dummy electrode layer 142 may be disposed on the second cover portion 113. However, the present disclosure is not particularly limited thereto, and when the dummy electrode layer (141 and 142) is disposed on both the first and second cover portions 112 and 113, bending strength may be further improved.

In this case, a dummy electrode layer included in the first cover portion 112 may be referred to as a first dummy electrode layer 141, and a dummy electrode layer included in the second cover portion 113 may be referred to as a second dummy electrode layer 142. The first cover portion 112 may include a plurality of first dummy electrode layers 141 disposed to be spaced apart from each other in the first direction, and the second cover portion 113 may include a plurality of second dummy electrode layers 142 disposed to be spaced apart from each other in the first direction.

For a more specific example of the dummy electrode layer (141 and 142), the dummy electrode layer (141 and 142) may include dummy electrodes 141-1, 141-2, 142-1, and 142-2 disposed to be spaced apart from each other in the second direction and connected to the external electrode (131 and 132).

In this case, the first dummy electrode layer 141 may include 1-1 and 1-2 dummy electrodes 141-1 and 141-2 respectively connected to the first and second external electrodes 131 and 132, and the second dummy electrode layer 142 may include 2-1 and 2-2 dummy electrodes 142-1 and 142-2 respectively connected to the first and second external electrodes 131 and 132.

For example, the 1-1 dummy electrode 141-1 may be spaced apart from the fourth surface 4, may be exposed through the third surface 3 while being in contact with the third surface 3, and may be connected to the first external electrode 131 disposed on the third surface 3. The 1-2 dummy electrode 141-2 may be spaced apart from the third surface 3, may be exposed through the fourth surface 4 while in contact with the fourth surface 4, and may be connected to the second external electrode 132 disposed on the fourth surface 4.

In addition, the 2-1 dummy electrode 142-1 may be spaced apart from the fourth surface 4, may be exposed through the third surface 3 while in contact with the third surface 3, and may be connected to the first external electrode 131 disposed on the third surface 3. The 2-2 dummy electrode 142-2 may be spaced apart from the third surface 3, may be exposed through the fourth surface 4 while in contact with the fourth surface 4, and may be connected to the second external electrode 132 disposed on the fourth surface 4.

As described above, the dummy electrode layer (141 and 142) may include a plurality of dummy electrode layers (141 and 142) spaced apart from each other in the first direction.

In this case, “the dummy electrode layer (141 and 142) may be spaced apart from each other in the first direction” may mean that the dummy electrode layer (141 and 142) may be alternately disposed with the second dielectric layer of the cover portion interposed therebetween in the first direction.

For example, the first cover portion 112 may include a plurality of first dummy electrode layers 141 alternately disposed with the second dielectric layer interposed therebetween in the first direction, and the second cover portion 113 may include a plurality of second dummy electrode layers 142 alternately disposed with the second dielectric layer interposed therebetween in the first direction.

The first and second cover portions 112 and 113 may include a plurality of first and second dummy electrode layer (141 and 142), respectively, to improve more effectively bending strength. In this case, all of the plurality of first and second dummy electrode layer (141 and 142) may be disposed in a position or a region spaced apart from the capacitance forming portion Ac by 42% or more and 71% or less in the first direction, among the cover portion (112 and 113).

A material forming the dummy electrode layer (141 and 142) is not particularly limited, and may use the same material as the internal electrode layer. For example, the dummy electrode layer (141 and 142) may include one or more of nickel (Ni), copper (Cu), palladium (Pd), silver (Ag), gold (Au), platinum (Pt), tin (Sn), tungsten (W), titanium (Ti), and an alloy thereof.

However, the present disclosure is not particularly limited thereto, and the dummy electrode layer (141 and 142) may use a different material from the internal electrode layer.

More specifically, the internal electrode layer may include a first conductive metal as a main component, and the dummy electrode layer (141 and 142) may include a second conductive metal as a main component, and the first and second conductive metals may be different conductive metals.

In this case, the second conductive metal may have at least one of a tensile strength or an elastic modulus (Young's modulus), higher than that of the first conductive metal. Depending on an environment in which the multilayer electronic component 100 is used, a material having at least one of a tensile strength or an elastic modulus, higher than that of the first conductive metal, may be used as the second conductive metal.

For example, when the first conductive metal is nickel (Ni), the second conductive metal may be at least one of a tungsten (W), titanium (Ti), a palladium (Pd) alloy, or a platinum (Pt) alloy, having a tensile strength, higher than nickel (Ni). In this case, the palladium (Pd) alloy may mean all alloys including palladium (Pd) having a tensile strength, higher than nickel (Ni), and the platinum (Pt) alloy may include all alloys including platinum (Pt) having a tensile strength, higher than nickel (Ni).

As another example, when the first conductive metal is nickel (Ni), the second conductive metal may be at least one of tungsten (W), titanium (Ti), palladium (Pd), or platinum (Pt) having an elastic modulus, higher than nickel (Ni).

Although the first conductive metal is nickel (Ni) as an example, the present disclosure is not particularly limited thereto, and the second conductive metal is also not limited to the aforementioned metals. The tensile strength of the first and second conductive metals may be measured by the Universal Testing Machine and the elastic modulus of the first and second conductive metals may be measured from the slope of the stress-strain curve in the elastic deformation region for each metal. Other methods and/or tools appreciated by one of ordinary skill in the art, even if not described in the present disclosure, may also be used.

The multilayer electronic component 100 may include a side margin region (114 and 115) which may be a third direction end region of the internal electrode layer.

More specifically, the side margin region (114 and 115) may include a first side margin region 114 disposed between the internal electrode layer and the fifth surface 5, and a second side margin region 115 disposed between the internal electrode layer and the sixth surface 6.

As illustrated, the side margin region (114 and 115) may mean a region between a third direction ends of the internal electrode layer and a boundary surface of the body 110, based on the first and third direction cross-sections of the body 110.

The side margin region (114 and 115) may refer to a ceramic green sheet region excluding an internal electrode layer when a paste for the internal electrode layer is applied to a ceramic green sheet applied to the capacitance forming portion Ac except for the side margin region (114 and 115).

The side margin region (114 and 115) may basically play a role in preventing damage to the internal electrode layer due to physical or chemical stress.

The first side margin region 114 and the second side margin region 115 may not include the internal electrode layer, may include the same material as the first dielectric layer 111, and, for example, may correspond to a portion of the first dielectric layer 111. For example, the first side margin region 114 and the second side margin region 115 may include a dielectric material, and, for example, may include a barium titanate (BaTiO₃)-based dielectric material.

A third direction length wm of the side margin region (114 and 115) does not need to be specifically limited, and the following description of the third direction length wm of the side margin region (114 and 115) may mean a third direction length wm of each of the first side margin region 114 and the second side margin region 115.

To more easily achieve miniaturization and high capacitance of the multilayer electronic component 100, the third direction length wm of the side margin region (114 and 115) may be 50 μm or less, preferably 30 μm or less, and more preferably 20 μm or less in ultra-small products.

In addition, the third direction length wm of the side margin region (114 and 115) may mean a third direction average length wm of each of the first and second side margin regions (114 and 115), or may mean a third direction average length wm of the first and second side margin regions (114 and 115).

The third direction average length of the side margin region (114 and 115) may be measured by scanning images of the first and third direction cross-sections of the body 110 with a scanning electron microscope (SEM) at 10,000× magnification. More specifically, the third direction average length wm may mean an average value calculated by measuring lengths in the third direction of a side margin region at five (5) equally spaced points in the first direction in scanned images.

In an embodiment of the present disclosure, a structure in which the multilayer electronic component 100 has two external electrodes (131 and 132) is illustrated, but the number, shapes, or the like of external electrodes (131 and 132) may be changed depending on a shape of the internal electrode layer or other purposes.

The external electrode (131 and 132) may be disposed on the body 110, and may be connected to the internal electrode layer.

More specifically, the external electrode (131 and 132) may be disposed on the third and fourth surfaces 3 and 4 of the body 110, respectively, and may include first and second external electrodes 131 and 132 connected to the internal electrode layer.

More specifically, in an embodiment of the present disclosure, the first and second external electrodes 131 and 132 may be connected to the first and second internal electrodes 121 and 122 included in the first and second internal electrode layers, respectively. In addition, in another embodiment of the present disclosure, the first and second external electrodes 131 and 132 may be connected to the third and fourth internal electrodes 221 and 222 included in the third internal electrode layer, respectively.

In addition, the external electrode (131 and 132) may be disposed to extend on portions of the first and second surfaces 1 and 2 of the body 110, or may be disposed to extend on portions of the fifth and sixth surfaces 5 and 6 of the body 110. For example, the first external electrode 131 may be disposed on the third surface 3 of the body 110 and portions of the first, second, fifth, and sixth surfaces 1, 2, 5, and 6 of the body 110, and the second external electrode 132 may be disposed on the fourth surface 4 of the body 110 and portions of the first, second, fifth, and sixth surfaces 1, 2, 5, and 6 of the body 110.

The external electrode (131 and 132) may be formed of any material as long as they have electrical conductivity, such as metal or the like, and a specific material may be determined in consideration of electrical characteristics, structural stability, or the like, and may further have a multilayer structure.

A material having excellent electrical conductivity may be used as a conductive metal included in the external electrode (131 and 132). For example, the conductive metal may include one or more selected from the group consisting of nickel (Ni), copper (Cu), palladium (Pd), silver (Ag), gold (Au), platinum (Pt), tin (Sn), tungsten (W), titanium (Ti), and an alloy thereof, but is not particularly limited thereto.

The external electrode (131 and 132) may include an electrode layer disposed on the body 110 and a plating layer disposed on the electrode layer.

In this case, the electrode layer may include at least one of a first electrode layer (131a and 132a) disposed on the body 110, and a second electrode layer (131b and 132b) disposed on the first electrode layer (131a and 132a).

A plating layer (131c and 132c) may include at least one of a first plating layer disposed on at least one of the first and second electrode layers, or a second plating layer disposed on the first plating layer, but is not particularly limited thereto. In the drawings of the present disclosure, a case in which the plating layer has one layer is illustrated, but it may not be limited thereto, and a structure in which a plurality of plating layers are stacked and disposed may be included. The contents of the electrode layer and the plating layer will be described in more detail below.

The electrode layer may be formed by transferring a sheet including a conductive metal onto the body 110. Alternatively, the electrode layer may be formed by applying and then sintering a conductive paste for an external electrode including a conductive metal to the body 110, or may be formed by dipping the body 110 into a conductive paste for an external electrode including a conductive metal, but is not particularly limited thereto.

The first electrode layer (131a and 132a) may include a third conductive metal and glass, and the second electrode layer (131b and 132b) may include a fourth conductive metal and a resin.

The glass included in the first electrode layer (131a and 132a) may play a role of improving bonding with the body 110, and the resin included in the second electrode layer (131b and 132b) may play a role of improving bending strength.

The third conductive metal included in the first electrode layer (131a and 132a) and the fourth conductive metal included in the second electrode layer (131b and 132b) may be the same or different from each other, and when the first and second electrode layers (131a, 132a, 131b, and 132b) include a plurality of conductive metals, only a portion thereof may include the same conductive metal, but is not particularly limited.

The third conductive metal included in the first electrode layer (131a and 132a) may play a role in electrically connecting with an internal electrode of the internal electrode layer.

The third conductive metal included in the first electrode layer (131a and 132a) is not particularly limited as long as it is a material electrically connected to the internal electrode of the internal electrode layer, and for example, may include at least one of nickel (Ni), copper (Cu), palladium (Pd), silver (Ag), gold (Au), platinum (Pt), tin (Sn), tungsten (W), titanium (Ti), or an alloy thereof.

The fourth conductive metal included in the second electrode layer (131b and 132b) may play a role of electrically connecting to the first electrode layer (131a and 132a).

The fourth conductive metal included in the second electrode layer (131b and 132b) is not particularly limited as long as it is a material electrically connected to the first electrode layer (131a and 132a), and may include at least one of nickel (Ni), copper (Cu), palladium (Pd), silver (Ag), gold (Au), platinum (Pt), tin (Sn), tungsten (W), titanium (Ti), or an alloy thereof.

The fourth conductive metal included in the second electrode layer (131b and 132b) may include at least one of a spherical particle or a flake-shaped particle. For example, the fourth conductive metal may include only flake-shaped particles, or may include only spherical particles, or may be a mixed form of flake-shaped particles and spherical particles. In this case, the spherical particle may also include a shape that may not be completely spherical, for example, a shape in which a length ratio of a major axis and a minor axis (major axis/minor axis) is 1.45 or less. The flake-type particle refers to a particle having a flat and elongated shape, and is not particularly limited, but for example, a length ratio of a major axis and a minor axis (major axis/minor axis) may be 1.95 or more. Lengths of the major and minor axes of the spherical particle and the flake-shaped particle may be measured from images obtained by scanning cross-sections in the first and second directions cut from a central portion of the multilayer electronic component in the third direction with a scanning electron microscope (SEM).

The resin included in the second electrode layer (131b and 132b) may play a role in securing bonding properties and absorbing shock, and is not particularly limited as long as it is mixed with the fourth conductive metal particle to make a paste, and may include, for example, an epoxy-based resin.

In addition, the second electrode layer (131b and 132b) may include an intermetallic compound.

The intermetallic compound may be included to further improve electrical connectivity with the first electrode layer (131a and 132a). The intermetallic compound may serve to improve electrical connectivity by connecting a plurality of fourth conductive metal particles, and may serve to surround and connect the plurality of fourth conductive metal particles to each other.

In this case, the intermetallic compound may include a metal having a melting point, lower than a curing temperature of a resin. For example, since the intermetallic compound includes a metal having a melting point, lower than a curing temperature of a resin, the metal having a melting point, lower than a curing temperature of a resin, may melt during a drying process and a curing process to form some of metal particles and the intermetallic compound, to surround the metal particles. In this case, the intermetallic compound may include a low melting point metal of 300° C. or less.

For example, the intermetallic compound may include tin (Sn) having a melting point of 213 to 220° C. During the drying process and the curing process, tin (Sn) may be melted, and the melted tin (Sn) may wet the third conductive metal particles having a high melting point, such as Ag, Ni, or Cu, by capillary action, and may react with a portion of silver (Ag), nickel (Ni), or copper (Cu) metal particles to form intermetallic compounds such as Ag₃Sn, Ni₃Sn₄, Cu₆Sn₅, Cu₃Sn, or the like. Silver (Ag), nickel (Ni), or copper (Cu) that did not participate in the reaction may remain as metal particles.

Therefore, the plurality of fourth conductive metal particles may include at least one of silver (Ag), nickel (Ni), or copper (Cu), and the intermetallic compounds may include one or more of Ag₃Sn, Ni₃Sn₄, Cu₆Sn₅, and Cu₃Sn.

The plating layer (131c and 132c) may play a role of improving mounting characteristics.

A type of the plating layer (131c and 132c) is not particularly limited, and for example, may include at least one of nickel (Ni), tin (Sn), silver (Ag), palladium (Pd), or an alloy thereof.

The plating layer (131c and 132c) may be a single layer or may be a plurality of layers.

More specifically, for example, the plating layer may be a nickel (Ni) plating layer or a tin (Sn) plating layer, and may be in a configuration in which a nickel (Ni) plating layer and a tin (Sn) plating layer are sequentially formed on an electrode layer, or may be in a configuration in which a tin (Sn) plating layer, a nickel (Ni) plating layer, and a tin (Sn) plating layer are sequentially formed. In addition, the plating layer may include a plurality of nickel (Ni) plating layers and/or a plurality of tin (Sn) plating layers.

A size of the multilayer electronic component 100 does not need to be particularly limited.

To simultaneously achieve improved bending strength, miniaturization, and high capacitance, thicknesses of a dielectric layer and an internal electrode should be reduced to increase the number of stacks, and dummy electrodes should be disposed on a cover portion. Therefore, an effect according to the present disclosure may be more prominent in the multilayer electronic component 100 having a size of 3216 (length×width: 3.2 mm×1.6 mm, length and width satisfy an error of +10%) or less.

Hereinafter, the present disclosure will be described in more detail through examples, but is intended to help a specific understanding of the present disclosure, and the scope of the present disclosure is not limited by the examples.

### Test Examples

The following Test Examples 1 to 4 related to multilayer electronic components in which first and second cover portions, having an average first direction length of 380 μm, were disposed on both end surfaces of a capacitance forming portion in the first direction, and were manufactured in the same manner except that dummy electrodes were disposed in different positions (d) from the capacitance forming portion in the first direction.

The first and second cover portions of Test Examples 1 to 4 included first and second dummy electrode layers, respectively, and the first dummy electrode layer included 1-1 and 1-2 dummy electrodes disposed to be spaced apart from each other in the second direction, and the second dummy electrode layer included 2-1 and 2-2 dummy electrodes disposed to be spaced apart from each other in the second direction.

In Test Example 1, a dummy electrode layer was disposed in a position spaced apart from the capacitance forming portion by a first direction average length (10 μm) of a first dielectric layer.

In Test Example 2, a dummy electrode layer was disposed in a position spaced apart from the capacitance forming portion by 160 μm in the first direction. For example, a dummy electrode layer was disposed in a position spaced apart by 42% from an internal electrode layer disposed on an outermost layer of the capacitance forming portion in the first direction, among the cover portions.

In Test Example 3, a dummy electrode layer was disposed in a position spaced apart from the capacitance forming portion by 270 μm in the first direction. For example, a dummy electrode layer was disposed in a position spaced apart from an internal electrode layer disposed on an outermost layer of the capacitance forming portion by 71% in the first direction, among the cover portions.

In Test Example 4, a dummy electrode layer was disposed in a position spaced apart from the capacitance forming portion by 370 μm in the first direction. For example, a dummy electrode layer was disposed in a position spaced apart from first and second surfaces of the body in the first direction by a first direction average length (10 μm) of a first dielectric layer.

The following [Table 1] evaluates bending strength of samples of Test Examples 1 to 3.

For bending strength evaluation (AEC-Q200 conditions), 20 samples were mounted on a substrate for each of Test Examples 1 to 3, and then the bending strength evaluation was performed. Among the samples, those having a capacitance change of 10% or more or cracks in the body were evaluated as poor, and those having a capacitance change of less than 10% and no cracks were evaluated as good. The number of good products among the total number of samples according to a bending strength pressing depth (mm) was rounded from a first decimal place and expressed as a percentage (%).

TABLE 1

| Bending | | | |
|---|---|---|---|
| Strength | | | |
| Pressing | | | |
| Depth | Test Example | Test Example | Test Example |
| (mm) | 1 | 2 | 3 |
| 1 | 100% | 100% | 100% |
| 2 | 100% | 100% | 100% |
| 3 | 80% | 100% | 100% |
| 4 | 20% | 30% | 100% |
| 5 | 0% | 0% | 50% |
| 6 | 0% | 0% | 10% |
| 7 | 0% | 0% | 0% |
| 8 | 0% | 0% | 0% |
| 9 | 0% | 0% | 0% |
| 10 | 0% | 0% | 0% |

In Test Examples 2 and 3, in which the dummy electrode layer was located in a position of the cover portion spaced apart from the capacitance forming portion by 42% or more and 71% or less in the first direction, it can be confirmed that good characteristics were exhibited in the bending strength evaluation, whereas in Test Example 1, in which the dummy electrode layer was located in a position of the cover portion spaced apart from the capacitance forming portion by less than 42% in the first direction, it can be confirmed that poor characteristics were exhibited in the bending strength evaluation. In addition, in Test Example 4, in which the dummy electrode layer was located in a position of the cover portion spaced apart from the capacitance forming portion by more than 71% in the first direction, the dummy electrode layer was disposed in a position adjacent to the first and second surfaces of the body to oxidize at least a portion of the dummy electrode layer, and problems such as arc discharge occurred, such that the bending strength evaluation could not be performed.

From this, it can be confirmed that when the dummy electrode was located in a position of the cover portion spaced apart from the capacitance forming portion by 42% or more and 71% or less in the first direction, the bending strength characteristics or the like was improved.

In addition, the expression ‘an embodiment’ used in this specification does not mean the same embodiment, and may be provided to emphasize and describe different unique characteristics. However, an embodiment presented above may not be excluded from being implemented in combination with features of another embodiment. For example, although the description in a specific embodiment is not described in another example, it may be understood as an explanation related to another example, unless otherwise described or contradicted by the other embodiment.

The terms used in this disclosure are used only to illustrate various examples and are not intended to limit the present inventive concept. Singular expressions include plural expressions unless the context clearly dictates otherwise.

One of the various effects of the present disclosure is to improve bending strength of a multilayer electronic component.

Various advantages and effects of the present disclosure are not limited to the above-described contents, and can be more easily understood in the process of explaining specific embodiments of the present disclosure.

While example embodiments have been illustrated and described above, it will be apparent to those skilled in the art that modifications and variations could be made without departing from the scope of the present disclosure as defined by the appended claims.

What is claimed is:

1. A multilayer electronic component comprising:
a body including:
a capacitance forming portion including a dielectric layer and internal electrode layers alternately disposed with the dielectric layer in a first direction, and
a cover portion disposed on both end surfaces of the capacitance forming portion in the first direction, the body including first and second surfaces opposing each other in the first direction, third and fourth surfaces connected to the first and second surfaces and opposing each other in a second direction, and fifth and sixth surfaces connected to the first to fourth surfaces and opposing each other in a third direction; and
an external electrode disposed on the body,
wherein the cover portion includes a plurality of dummy electrode layers disposed to be spaced apart from the capacitance forming portion in the first direction, and the plurality of dummy electrode layers include dummy electrodes disposed to be spaced apart from each other in the second direction and connected to the external electrode,
among the plurality of dummy electrode layers, a dummy electrode layer disposed in a position closest to the capacitance forming portion is disposed in a position spaced apart from the capacitance forming portion by d in the first direction, and,
if an average length in the first direction of the dielectric layer is td, td and d satisfy td<d.

2. The multilayer electronic component of claim 1, wherein the plurality of dummy electrode layers are disposed in a position spaced apart from the capacitance forming portion by 42% or more and 71% or less of the average length of the cover portion.

3. The multilayer electronic component of claim 1, wherein the external electrode includes a first external electrode and a second external electrode, disposed to be spaced apart from each other,
the internal electrode layers include a first internal electrode layer and a second internal electrode layer, disposed alternately in the first direction, with the dielectric layer therebetween, and
the first internal electrode layer includes a first internal electrode connected to the first external electrode, and the second internal electrode layer includes a second internal electrode connected to the second external electrode.

4. The multilayer electronic component of claim 3, wherein the cover portion includes a first cover portion disposed on a first end surface of the capacitance forming portion in the first direction, and a second cover portion disposed on a second end surface of the capacitance forming portion in the first direction,
the plurality of dummy electrode layers include:
a plurality of first dummy electrode layers included in the first cover portion and disposed to be spaced apart from each other in the first direction, and
a plurality of second dummy electrode layers included in the second cover portion and disposed to be spaced apart from each other in the first direction,
the plurality of first dummy electrode layers include a 1-1 dummy electrode and a 1-2 dummy electrode, connected to the first and second external electrodes, respectively, and
the plurality of second dummy electrode layers include a 2-1 dummy electrode and a 2-2 dummy electrode, connected to the first and second external electrodes, respectively.

5. The multilayer electronic component of claim 1, wherein the external electrode includes a first external electrode and a second external electrode, disposed to be spaced apart from each other,
the internal electrode layers include a third internal electrode layer and a fourth internal electrode layer, disposed alternately in the first direction, with the dielectric layer therebetween,
the third internal electrode layer includes a third internal electrode and a fourth internal electrode, disposed to be spaced apart from each other in the second direction and connected to the first and second external electrodes, respectively,
the fourth internal electrode layer includes a floating electrode not connected to the first and second external electrodes, and
the dummy electrodes include a first dummy electrode and a second dummy electrode, connected to the first and second external electrodes, respectively.

6. The multilayer electronic component of claim 5, wherein the cover portion includes a first cover portion disposed on a first end surface of the capacitance forming portion in the first direction, and a second cover portion disposed on a second end surface of the capacitance forming portion in the first direction,
the plurality of dummy electrode layers include:
a plurality of first dummy electrode layers included in the first cover portion and disposed to be spaced apart from each other in the first direction, and
a plurality of second dummy electrode layers included in the second cover portion and disposed to be spaced apart from each other in the first direction,
the plurality of first dummy electrode layer include a 1-1 dummy electrode and a 1-2 dummy electrode, connected to the first and second external electrodes, respectively, and
the plurality of second dummy electrode layer include a 2-1 dummy electrode and a 2-2 dummy electrode, connected to the first and second external electrodes, respectively.

7. The multilayer electronic component of claim 1, wherein the internal electrode layers include a first conductive metal as a main component, and the dummy electrodes include a second conductive metal as a main component, and
the first and second conductive metals are different conductive metals.

8. The multilayer electronic component of claim 7, wherein the second conductive metal has at least one of a tensile strength or an elastic modulus, higher than that of the first conductive metal.

9. The multilayer electronic component of claim 5, wherein the cover portion includes:
a first cover portion disposed on a first end surface of the capacitance forming portion in the first direction and including the first dummy electrode, and
a second cover portion disposed on a second end surface of the capacitance forming portion in the first direction and including the second dummy electrode, and
an average length in the first direction of each of the first and second cover portions is 400 μm or less.

10. The multilayer electronic component of claim 1, satisfying td≤10 μm.

11. The multilayer electronic component of claim 8, wherein the tensile strength of the second conductive metal is higher than a tensile strength of the first conductive metal.

12. The multilayer electronic component of claim 8, wherein the elastic modulus of the second conductive metal is higher than an elastic modulus of the first conductive metal.

13. The multilayer electronic component of claim 8, wherein the tensile strength and the elastic modulus of the second conductive metal are higher than a tensile strength and an elastic modulus of the first conductive metal, respectively.

14. The multilayer electronic component of claim 1, wherein the plurality of dummy electrode layers are disposed to be spaced apart from each of the first surface and the second surface of the body.
